(19) United States
(12) Patent Application Publication
(10) Pub. No.: US 2022/0185923 A1
(43) Pub. Date: Jun. 16, 2022

(54) CATALYST SYSTEM

(71) Applicant: BOREALIS AG, Vienna (AT)

(72) Inventors: Luigi Maria Cristoforo RESCONI, Linz (AT); Anna FAIT, Linz (AT); Rafael SABLONG, NJ Eindhoven (NL); Vyatcheslav V. IZMER, Moscow (RU); Dmitry S. KONONOVICH, Moscow (RU); Alexander Z. VOSKOBOYNIKOV, Moscow (RU)

(21) Appl. No.: 17/603,090

(22) PCT Filed: Apr. 9, 2020
(86) PCT No.: PCT/EP2020/060125

§ 371 Date: Oct. 12, 2021

(30) Foreign Application Priority Data
Apr. 12, 2019 (EP) 19168906.6

(51) Int. Cl. C08F 210/16; C07F 17/00

(52) U.S. Cl. CPC C08F 210/16; C08F 2420/00; C07F 17/00

(57) ABSTRACT

The present invention relates to a catalyst system for producing ethylene copolymers in a high temperature solution process, the catalyst system comprising (i) a metallocene complex of a group 4 transition metal comprising at least one ligand selected from optionally substituted cyclopentadienyl (Cp), indenyl (Ind) and fluorenyl (Flu) ligands and (ii) a solid alkyl aluminium oxide cocatalyst The invention relates also to the preparation of the catalyst system, use thereof in the high temperature solution process and to a process comprising polymerizing ethylene and a C₄₋₁₀ alpha-olefin comonomer in a high temperature solution process in the presence of the catalyst system.

The present invention relates to a new catalysts system, which is able to produce polyethylene copolymers in a high temperature solution polymerization process. The new catalyst system comprises a substituted, bridged metallocene complex of a group 4 transition metal, in combination with a specific cocatalyst in solid form. This combination remarkably gives rise to catalyst systems with an improved balance of productivity, comonomer incorporation ability and molecular weight capability.

Metallocene catalysts have been used to manufacture polyolefins for decades. Countless academic and patent publications describe the use of these catalysts in olefin polymerization. Metallocenes are today used industrially and polypropylenes as well polyethylenes are often produced using cyclopentadienyl based catalyst systems with different substitution patterns.

Several of these metallocene catalysts have been described in several patent publications for the use in solution polymerization for producing polyethylene homo- or copolymers.

For example WO 2000024792 describes a catalyst system comprising hafnocene catalyst complex derived from a biscyclopentadienyl hafnium organometallic compound having i) at least one unsubstituted cyclopentadienyl ligand or aromatic fused-ring substituted cyclopentadienyl ligand, ii) one substituted or unsubstituted, aromatic fused-ring substituted cyclopentadienyl ligand, and iii) a covalent bridge connecting the two cyclopentadienyl ligands. This bridge can be a single carbon substituted with two aryl groups, each of these aryl groups being substituted with a C₁-C₂₀ hydrocarbyl or hydrocarbylsilyl group, whereby at least one of these substituents is a linear C₃ or greater substituent.

In addition the catalyst system comprises an activating cocatalyst, which is a precursor ionic compound comprising a halogenated tetraaryl-substituted Group 13 anion, typically perfluorinated borate compounds, like N,N-Dimethylanilinium tetrakis(pentafluorphenyl) borate, as used in all examples.

Also numerous academic articles disclose the effect of ligand structure on high temperature ethylene homo-polymerization and copolymerization with various Cp-Flu metallocenes.

Perfluorinated borate activators for single site catalysts are widely used especially in high temperature solution polymerisation, where they have been shown to give satisfactory performance in polymerisation. However, these activators have a very low solubility in aliphatic hydrocarbons, requiring either to be dissolved in aromatic solvents or slurried in aliphatic solvents in order to be fed to the polymerisation process. Either solution has disadvantages: aromatic solvents are not desirable in the process due to their toxicity and a solid slurry requires a higher than stoichiometric activator to metallocene complex ratio, leading to a waste of an expensive component.

Analogously, also the metallocene complexes must have a relatively high solubility in aliphatic hydrocarbons

There are commercial activators used with single site catalysts, which are based on methylalumoxanes (MAO) or their mixtures with aluminium alkyls, e.g. MAO/tri-isobutylaluminum (MAO/TI BA), modified MAO (MMAO), and the like, i.e. which are not based on perfluorinated borates.

A catalytic system based on metallocene/MAO would be a desirable potential replacement for the currently used metallocene/borate systems, provided that it could be made free from aromatic solvents, like toluene.

An advantage of using an activated metallocene/MAO catalyst system would be that also complexes having a lower solubility in aliphatic hydrocarbons could be used, since the solubility is provided by the solvating power of MAO itself. However, MAO is commercially available as toluene solution while MMAO, which is free from toluene, is less efficient in activating such less soluble complexes.

Therefore, there is a need to find a new solution for a catalyst activation.

Thus, the object of the present invention is to provide a metallocene based catalyst system comprising a metallocene complex and a cocatalyst, where the solubility of the metallocene is not a restrictive feature in using such catalyst system in a high temperature solution process. Thus, the object of the present invention is to provide a new catalyst system, where no aromatic solvents are needed in the catalyst system.

Further, the object of the present invention is to provide a metallocene based catalyst system, where fluorinated borates are not used as activators and still the productivity remains on a good level, or is even improved without using such borates as activators.

Still another object of the present invention is to provide a metallocene based catalyst system, which is able to produce polyethylene polymers in a high temperature solution process having improved balance in molecular weight capability and comonomer incorporation ability.

In addition, the object of the present invention is to provide a method for producing the catalyst system as herein described.

Further, a process for producing ethylene copolymers in a high temperature process in the presence of the catalyst system as herein described is an object of the present invention.

For a process for producing ethylene copolymers to be efficient, it is important that the catalyst system used needs to fulfil a set of requirements as disclosed above. Comonomer incorporation, ability (comonomer reactivity) for higher comonomers (C4 to C12 comonomers), catalyst molecular weight capability and catalyst thermal stability must ensure the production of copolymers with density down to 0.85 g/cm³ and a melt index MI₂ (190° C., 2.16 kg) down to 0.3 g/10 min with high productivity. Catalyst molecular weight capability means the lowest achievable melt index for a given polymer density, monomer concentration and polymerization temperature.

Thus, although a lot of work has been done in the field of metallocene catalyst systems, there remains a need to find new metallocene based catalyst systems for ethylene copolymerization in a high temperature solution process. Such catalyst systems should be able to produce polymers with desired properties, and should have improved balance of productivity, comonomer incorporation ability and molecular weight capability. Further, there should be no restrictions in using different metallocenes with different solubility properties.

To solve the problems indicated above the inventors set out to develop a new catalyst system having superior polymerization behaviour over the above mentioned polymerization catalyst systems with respect to productivity, comonomer incorporation ability and molecular weight capability. In addition, the limitation posed by low metallocene solubility is no more an issue in the inventive catalyst system.

The present inventors have now found a new class of olefin polymerization catalyst systems, which are able to solve the problems disclosed above. According to the invention the new catalyst system comprises metallocene complexes in combination with a specific cocatalyst selected from solid alkyl aluminium oxides. Thus, use of borate cocatalysts can be avoided in the catalyst system. Thus, according to the preferred embodiment the catalyst system of the invention is a combination of one or more metallocene complexes and one or more cocatalysts selected from solid alkyl aluminium oxides, more preferable a combination of a metallocene and a cocatalyst selected from solid alkyl aluminium oxides.

The phrases “activator” and “cocatalyst” have the same meaning and are interchangeable terms in the present application.

### SUMMARY OF INVENTION

Thus, viewed from one aspect the invention relates to a catalyst system for producing ethylene copolymers in a high temperature solution process at a temperature greater than 100° C., the catalyst system comprising
(i) a metallocene complex of a group 4 transition metal comprising at least one ligand selected from optionally substituted cyclopentadienyl (Cp), indenyl (Ind) and fluorenyl (Flu) ligands and
(ii) a solid alkyl aluminium oxide cocatalyst.

Viewed from a second aspect the invention relates to a catalyst system for producing ethylene copolymers in a high temperature solution process at a temperature greater than 100° C., the catalyst system comprising
(i) a metallocene complex of a group 4 transition metal comprising at least one ligand selected from optionally substituted cyclopentadienyl (Cp), indenyl (Ind) and fluorenyl (Flu) ligands and
(ii) a solid alkyl alumoxane cocatalyst provided as a suspension in an aliphatic C₅ to C₂₄ hydrocarbon solvent or mixture of said aliphatic hydrocarbon solvents.

Viewed from another aspect the invention provides a process for the preparation of an ethylene copolymer comprising polymerizing ethylene and a C₄₋₁₂ alpha-olefin comonomer in a high temperature solution process at a temperature greater than 100° C. in the presence of a catalyst system comprising:
(i) a metallocene complex of a group 4 transition metal comprising at least one ligand selected from optionally substituted cyclopentadienyl (Cp), Indenyl (Ind) and fluorenyl (Flu) ligands and
(ii) a solid alkyl alumoxane cocatalyst.

Viewed still from another aspect the invention provides a process for the preparation of an ethylene copolymer comprising polymerizing ethylene and a C₄₋₁₂ alpha-olefin comonomer in a high temperature solution process at a temperature greater than 100° C. in the presence of a catalyst system comprising:
(i) a metallocene complex of a group 4 transition metal comprising at least one ligand selected from optionally substituted cyclopentadienyl (Cp), Indenyl (Ind) and fluorenyl (Flu) ligands and
(ii) a solid alkyl alumoxane cocatalyst provided as a suspension in an aliphatic C₅ to C₂₄ hydrocarbon solvent or mixture of said aliphatic hydrocarbon solvents.

Viewed from a further aspect the invention provides an ethylene C₄₋₁₂ alpha-olefin copolymer made by a process as hereinbefore defined.

Viewed from another aspect the invention provides use of a catalyst system comprising:
(i) a metallocene complex of a group 4 transition metal comprising at least one ligand selected from optionally substituted cyclopentadienyl (Cp), indenyl (Ind) and fluorenyl (Flu) ligands and
(ii) a solid alkyl alumoxane cocatalyst
   in a high temperature solution process at a temperature greater than 100° C. for preparing ethylene C₄₋₁₂ alpha-olefin copolymers.

Viewed from a further aspect the invention provides use of a catalyst system comprising:
(i) a metallocene complex of a group 4 transition metal comprising at least one ligand selected from optionally substituted cyclopentadienyl (Cp), indenyl (Ind) and fluorenyl (Flu) ligands and
(ii) a solid alkyl alumoxane cocatalyst cocatalyst provided as a suspension in an aliphatic C₅ to C₂₄ hydrocarbon solvent or mixture of said aliphatic hydrocarbon solvents in a high temperature solution process at a temperature greater than 100° C. for preparing ethylene C₄₋₁₂ alpha-olefin copolymers.

Alkyl aluminium oxide and alkyl alumoxane have the same meaning and are interchangeable terms in the present application.

### DETAILED DESCRIPTION OF THE INVENTION

Metallocene Complex

The single site metallocene complex used for manufacture of the ethylene C₄₋₁₂ alpha-olefin copolymer is a metallocene complex of group 4 transition metal comprising at least one ligand selected from optionally substituted cyclopentadienyl (Cp), Indenyl (Ind) and fluorenyl (Flu) ligands and optionally containing a covalent bridge connecting the two ligands.

Such metallocene complexes, without a bridge are of formula (A)

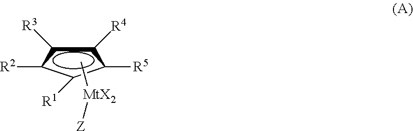

where Z is a ligand coordinating to Mt,

Mt is Ti, Zr, Hf or a mixture of Zr and Hf,

X is a sigma ligand,

R¹ to R⁵ are independently a hydrogen atom, a saturated or unsaturated, linear, branched or cyclic C₁-C₁₀ hydrocarbyl group, a C₆-C₁₀ aryl group, a C₆-C₂₀ alkylaryl group or a C₆-C₂₀ arylalkyl group, which optionally contains one or two heteroatoms or silicon atoms, or two adjacent groups of R¹ to R⁵ can form a ring comprising from 4 to 8 ring atoms, where the atoms being part of the formed ring can be substituted by one or more R¹² groups selected from saturated or unsaturated, linear or branched C₁-C₁₀ hydrocarbyl, a C₅-C₁₀ aromatic group, C₆-C₂₀ alkylaryl or C₆-C₂₀ arylalkyl groups, which optionally contain one or two heteroatoms or silicon atoms.

Mt is Ti, Zr, Hf or a mixture of Zr and Hf means that, complex of formula (A) may comprise a mixture of complexes (A) with Zr or Hf metal. Thus, Mt is Ti, Zr, Hf or a mixture of Zr and Hf, wherein the mixture of Zr and Hf is a mixture of complexes of formula (A) with Zr or Hf metal. Especially, it is provided that in more than 50% by moles of the complex of Formula (A) Mt is Hf.

According to an embodiment R¹ to R⁵ are independently a hydrogen atom, a saturated or unsaturated, linear, branched or cyclic C₁-C₁₀ hydrocarbyl group, a C₆-C₁₀ aryl group, a C₆-C₂₀ alkylaryl group or a C₆-C₂₀ arylalkyl group, in which up to two C atoms of the arylic ring(s) can be replaced by up to two heteroatoms, and which optionally carry substituents attached to their ring atoms, and such substituents optionally contain one or two heteroatoms or silicon atoms, or two adjacent groups of R¹ to R⁵ can form a ring comprising from 4 to 8 ring atoms, where the atoms being part of the formed ring can be substituted by one or more R¹² groups selected from saturated or unsaturated, linear or branched C₁-C₁₀ hydrocarbyl, a C₅-C₁₀ aromatic group, C₆-C₂₀ alkylaryl or C₆-C₂₀ arylalkyl groups, which optionally contain one or two heteroatoms or silicon atoms.

Ligand Z is an organic or inorganic ligand, and may be selected from a great variety of groups. Z may be e.g. a non-substituted or substituted cyclopentadienyl group, a hydrocarbyl group, amino group, imino group, oxygen, phosphimine, alkyl silyl group, alkoxy group.

The heteroatoms belong to groups 15 to 16, and are especially N, P, O or S in formula (A).

According to another embodiment, the single site metallocene complex used for manufacture of ethylene C₄₋₁₂ alpha-olefin copolymer is a metallocene complex of group 4 transition metal, comprising at least one ligand selected from optionally substituted cyclopentadienyl (Cp), Indenyl (Ind) and fluorenyl (Flu) ligands, a ligand Z, and covalent bridge connecting the two ligands.

Such metallocenes with the bridge are of formula (B)

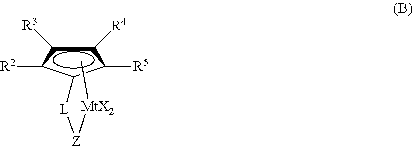

where Z is a ligand coordinated to Mt,
Mt is Ti, Zr, Hf or a mixture of Zr and Hf, as defined in metallocene of formula (A)
X is a sigma ligand,
R² to R⁵ are as defined in metallocene of formula (A)
L is a covalent bridge connecting the ligands.
Z is as defined in metallocen of formula (A)

According to a preferred embodiment the invention can be effected with a metallocene complex of a group 4 transition metal comprising two ligands selected from optionally substituted cyclopentadienyl (Cp), indenyl (Ind) and fluorenyl (Flu) ligands.

According to a more preferred embodiment the invention can be effected with a metallocene complex of a group 4 transition metal comprising two ligands selected from optionally substituted cyclopentadienyl (Cp), indenyl (Ind) and fluorenyl (Flu) ligands and a covalent bridge connecting the two ligands.

According to a preferred embodiment the invention is effected with a metallocene complex of Formula (I)

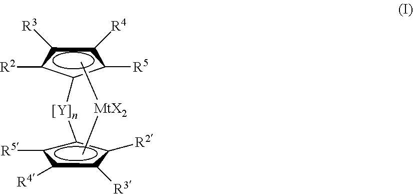

wherein
Mt is Zr, Hf or a mixture of Hf and Zr,
X is a sigma ligand,
Y is a bridge of formula −(WR^{y})ₙ−,
n is 1, 2 or 3, preferably 1 or 2, more preferably 1,
W is C or Si;
each R^{y} is independently a hydrogen atom, a saturated or unsaturated, linear, branched or cyclic C₁-C₁₀ hydrocarbyl group, a C₆-C₁₀ aryl, a C₆-C₂₀ alkylaryl group or a C₆-C₂₀ arylalkyl group, any of which optionally contains one or two heteroatoms or silicon atoms, or a heteroatom-containing saturated or unsaturated ring of 3 to 7 ring-atoms optionally substituted with a linear, branched or cyclic saturated or unsaturated C₁ to C₂₀ hydrocarbyl group;

R² to R⁵ and R^{2′} to R^{5′} are independently hydrogen or a saturated or unsaturated, linear, branched or cyclic C₁-C₁₀ hydrocarbyl group, a C₆-C₁₀ aryl, C₆-C₂₀ alkylaryl or C₆-C₂₀ arylalkyl group, which optionally contain one or two heteroatoms or silicon atoms, or any of the two adjacent groups of R¹ to R⁵ and/or of R^{1′} to R^{5′} can form a ring comprising from 4 to 8 ring atoms.

The atoms being part of the formed ring may be further substituted by one or more R¹² groups selected from a saturated or unsaturated, linear or branched C₁-C₁₀ hyrocarbyl, C₆-C₁₀ aryl, C₆-C₂₀ alkylaryl or C₆-C₂₀ arylalkyl groups, which may contain one or two heteroatoms or silicon atoms.

Mt is Zr, Hf or a mixture of Zr and Hf means that, complex of formula (I) may comprise a mixture of complexes (I) with Zr or Hf metal. Thus, Mt is Zr, Hf or a mixture of Zr and Hf, wherein the mixture of Zr and Hf is a mixture of complexes of formula (I) with Zr or Hf metal.

Especially, it is provided that in more than 50% by moles of the complex of Formula (I) Mt is Hf.

The heteroatoms belong to groups 15 to 16, and are especially N, P, O or S in formula (I).

According to an embodiment R¹ to R⁵ and R^{2′} to R^{5′} in formula (I) are independently a hydrogen atom, a saturated or unsaturated, linear, branched or cyclic C₁-C₁₀ hydrocarbyl group, a C₆-C₁₀ aryl group, a C₆-C₂₀ alkylaryl group or a C₆-C₂₀ arylalkyl group, in which up to two C atoms of the arylic ring(s) can be replaced by up to two heteroatoms, and which optionally carry substituents attached to their ring atoms, and such substituents optionally contain one or two heteroatoms or silicon atoms, or two adjacent groups of R¹ to R⁵ and/or R^{2′} to R^{5′} can form a ring comprising from 4 to 8 ring atoms, where the atoms being part of the formed ring can be substituted by one or more R¹² groups selected from saturated or unsaturated, linear or branched C₁-C₁₀ hydrocarbyl, a C₅-C₁₀ aromatic group, C₆-C₂₀ alkylaryl or C₆-C₂₀ arylalkyl groups, which optionally contain one or two heteroatoms or silicon atoms.

In formulas (A), (B) and (I) each X, which may be the same or different, is a sigma ligand, preferably a hydrogen atom, a halogen atom, a R¹⁴, OR¹⁴, OSO₂CF₃, OCOR¹⁴, SR¹⁴, NR¹⁴₂ or PR¹⁴₂ group, where R¹⁴ is a linear or branched, cyclic or acyclic, C₁-C₂₀-alkyl, C₂-C₂₀-alkenyl, C₂-C₂₀-alkynyl, C₆-C₂₀-aryl, C₇-C₂₀-alkylaryl or C₇-C₂₀-arylalkyl group optionally containing one or more heteroatoms belonging to groups 15 or 16, or is SiR¹⁴₃, SiHR¹⁴₂ or SiH₂R¹⁴, where R¹⁴ is preferably C₁₋₆-alkyl, phenyl or benzyl group.

The term halogen includes fluoro, chloro, bromo and iodo groups, preferably chloro groups.

More preferably, each X is independently a halogen atom, a R¹⁴ or OR¹⁴ group, whereby R¹⁴ is a C₁₋₆-alkyl, phenyl or benzyl group.

Most preferably X is methyl, chloro or benzyl group. Still more preferably both X groups are the same.

According to a further preferred embodiment the invention is effected with a metallocene complex of Formula (II)

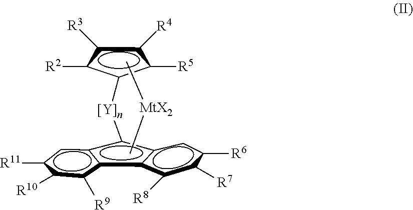

wherein
Mt is Zr, Hf or a mixture of Hf and Zr, wherein the mixture of Hf and Zr is a mixture of complexes of formula (II) with Zr or Hf metal,
X is a sigma ligand,
Y is a bridge of formula −(WR^{y})ₙ₋,
n is 1, 2 or 3, preferably 1 or 2, more preferably 1,
W is C or Si;
each R^{y} is as defined in formula (I),

R² to R¹¹ are independently hydrogen or a saturated or unsaturated, linear, branched or cyclic C₁-C₁₀ hydrocarbyl group, C₆-C₁₀ aryl, C₆-C₂₀ alkylaryl group or C₆-C₂₀ arylalkyl group, which optionally contain up to 2 heteroatoms or silicon atoms, or any two adjacent groups of R² to R¹¹ can form a ring, comprising from 4 to 8 atoms. The atoms being part of the formed ring may be further substituted by one or more R¹² groups selected from or a saturated or unsaturated, linear or branched C₁-C₁₀ hydrocarbyl, C₅-C₁₀ aromatic group, C₆-C₂₀ alkylaryl or C₆-C₂₀ arylalkyl groups, which may contain up to 2 heteroatoms or silicon atoms.

In the formula (II) each X is as defined in formulas (A), (B) and (I).

More preferably each X is independently a halogen atom or a R¹⁴ or OR¹⁴ group, whereby R¹⁴ is a C₁₋₆-alkyl, phenyl or benzyl group.

Most preferably X is methyl, chloro or benzyl group. Preferably, both X groups are the same.

Especially, it is provided that in more than 50% by moles of the complex of Formula (II) Mt is Hf.

According to an embodiment R⁵ to to R¹¹ in formula (II) are independently a hydrogen atom, a saturated or unsaturated, linear, branched or cyclic C₁-C₁₀ hydrocarbyl group, a C₆-C₁₀ aryl group, a C₆-C₂₀ alkylaryl group or a C₆-C₂₀ arylalkyl group, in which up to two C atoms of the arylic ring(s) can be replaced by up to two heteroatoms, and which optionally carry substituents attached to their ring atoms, and such substituents optionally contain one or two heteroatoms or silicon atoms, or two adjacent groups of R² to R¹¹ can form a ring comprising from 4 to 8 ring atoms, where the atoms being part of the formed ring can be substituted by one or more R¹² groups selected from saturated or unsaturated, linear or branched C₁-C₁₀ hydrocarbyl, a C₆-C₁₀ aromatic group, C₆-C₂₀ alkylaryl or C₆-C₂₀ arylalkyl groups, which optionally contain one or two heteroatoms or silicon atoms.

According to a more preferred embodiment, the invention is effected with a metallocene complex of formula (III):

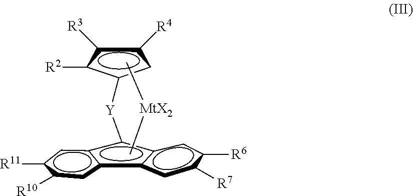

wherein
Mt, X, and R² to R⁴ and R⁶ to R¹¹ are as defined in formula (II) and
Y is a bridge of formula −(WR^{y})ₙ₋, where n is 1,
W is C or Si;
each R^{y} is as defined in formula (I).

According to an even more preferred embodiment, the metallocene complex has formula (IV):

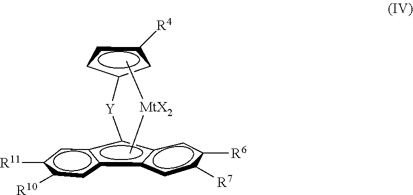

wherein Mt, X, Y and R⁴, R⁶, R⁷, R¹⁰ and R¹¹ are as defined in formula (III). According to a still more preferred embodiment, the metallocene complex has formula (V):

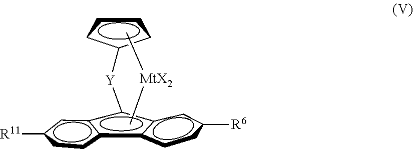

wherein Mt, X, Y and R⁶ and R¹¹ are as defined in formulas (III) and (IV)

In formula (V) most preferably, R⁶ and R¹¹ are tertiary alkyl groups, like tert-butyl, and X is methyl or chlorine.

Mt is preferably Hf.

In formulas (I) to (V) each R^{y} is more preferably a saturated or non-saturated linear, branched or cyclic C₄-C₁₀ hydrocarbyl group, C₆-C₁₀ aryl group, or a heteroatom containing non-saturated ring of 3 to 7 ring-atoms substituted with a saturated or unsaturated linear, branched or cyclic C₃-C₁₀ hydrocarbyl group.

Representative preferred complexes applicable to the present invention are dimethylmethylene(cyclopentadienyl)(fluorenyl) hafnium dimethyl methyl(phenyl)methylene(cyclopentadienyl)(fluorenyl) hafnium dimethyl (3-buten-1-yl)(methyl)methylene(cyclopentadienyl)(fluorenyl) hafnium dimethyl (3-buten-1-yl)(phenyl)methylene(cyclopentadienyl)(fluorenyl) hafnium dimethyl (cyclohexyl)(methyl)methylene(cyclopentadienyl)(fluorenyl) hafnium dimethyl (cyclohexyl)(phenyl)methylene(cyclopentadienyl)(fluorenyl) hafnium dimethyl diphenylmethylene(cyclopentadienyl)(fluorenyl) hafnium dimethyl (5-n-butylthienyl)(methyl)methylene(cyclopentadienyl)(fluorenyl) hafnium dimethyl (5-n-butylthienyl)(phenyl)methylene(cyclopentadienyl)(fluorenyl) hafnium dimethyl (5-methylthienyl)(methyl)methylene(cyclopentadienyl) (fluorenyl) hafnium dimethyl (5-methylthienyl)(n-butyl)methylene(cyclopentadienyl) (fluorenyl) hafnium dimethyl (5-methylthienyl)(phenyl)methylene(cyclopentadienyl) (fluorenyl) hafnium dimethyl dimethylmethylene(cyclopentadienyl)(fluorenyl) hafnium dichloride methyl(phenyl)methylene(cyclopentadienyl)(fluorenyl) hafnium dichloride (3-buten-1-yl)(methyl)methylene(cyclopentadienyl)(fluorenyl) hafnium dichloride (3-buten-1-yl)(phenyl)methylene(cyclopentadienyl)(fluorenyl) hafnium dichloride (cyclohexyl)(methyl)methylene(cyclopentadienyl)(fluorenyl) hafnium dichloride (cyclohexyl)(phenyl)methylene(cyclopentadienyl)(fluorenyl) hafnium dichloride diphenylmethylene(cyclopentadienyl)(fluorenyl) hafnium dichloride (5-n-butylthienyl)(methyl)methylene(cyclopentadienyl)(fluorenyl) hafnium dichloride (5-n-butylthienyl)(phenyl)methylene(cyclopentadienyl)(fluorenyl) hafnium dichloride (5-methylthienyl)(methyl)methylene(cyclopentadienyl)(fluorenyl) hafnium dichloride (5-methylthienyl)(n-butyl)methylene(cyclopentadienyl)(fluorenyl) hafnium dichloride (5-methylthienyl)(phenyl)methylene(cyclopentadienyl)(fluorenyl) hafnium dichloride dimethylmethylene(cyclopentadienyl)(2,7-di-tert-butylfluorenyl) hafnium dimethyl methyl(phenyl)methylene(cyclopentadienyl)(2,7-di-tert-butylfluorenyl) hafnium dimethyl (3-buten-1-yl)(methyl)methylene(cyclopentadienyl)(2,7-di-tert-butylfluorenyl) hafnium dimethyl (3-buten-1-yl)(phenyl)methylene(cyclopentadienyl)(2,7-di-tert-butylfluorenyl) hafnium dimethyl (cyclohexyl)(methyl)methylene(cyclopentadienyl)(2,7-di-tert-butylfluorenyl) hafnium dimethyl (cyclohexyl)(phenyl)methylene(cyclopentadienyl)(2,7-di-tert-butylfluorenyl) hafnium dimethyl diphenylmethylene(cyclopentadienyl)(2,7-di-tert-butylfluorenyl) hafnium dimethyl (5-n-butylthienyl)(methyl)methylene(cyclopentadienyl)(2,7-di-tert-butylfluorenyl) hafnium dimethyl (5-n-butylthienyl)(phenyl)methylene(cyclopentadienyl)(2,7-di-tert-butylfluorenyl) hafnium dimethyl (5-methylthienyl)(methyl)methylene(cyclopentadienyl)(2,7-di-tert-butylfluorenyl) hafnium dimethyl (5-methylthienyl)(n-butyl)methylene(cyclopentadienyl)(2,7-di-tert-butylfluorenyl) hafnium dimethyl (5-methylthienyl)(phenyl)methylene(cyclopentadienyl)(2,7-di-tert-butylfluorenyl) hafnium dimethyl dimethylmethylene(cyclopentadienyl)(2,7-di-tert-butylfluorenyl) hafnium dichloride methyl(phenyl)methylene(cyclopentadienyl)(2,7-di-tert-butylfluorenyl) hafnium dichloride (3-buten-1-yl)(methyl)methylene(cyclopentadienyl)(2,7-di-tert-butylfluorenyl) hafnium dichloride (3-buten-1-yl)(phenyl)methylene(cyclopentadienyl)(2,7-di-tert-butylfluorenyl) hafnium dichloride (cyclohexyl)(methyl)methylene(cyclopentadienyl)(2,7-di-tert-butylfluorenyl) hafnium dichloride (cyclohexyl)(phenyl)methylene(cyclopentadienyl)(2,7-di-tert-butylfluorenyl) hafnium dichloride diphenylmethylene(cyclopentadienyl)(2,7-di-tert-butylfluorenyl) hafnium dichloride (5-n-butylthienyl)(methyl)methylene(cyclopentadienyl)(2,7-di-tert-butylfluorenyl) hafnium dichloride (5-n-butylthienyl)(phenyl)methylene(cyclopentadienyl)(2,7-di-tert-butylfluorenyl) hafnium dichloride (5-methylthienyl)(methyl)methylene(cyclopentadienyl)(2,7-di-tert-butylfluorenyl) hafnium dichloride (5-methylthienyl)(n-butyl)methylene(cyclopentadienyl)(2,7-di-tert-butylfluorenyl) hafnium dichloride (5-methylthienyl)(phenyl)methylene(cyclopentadienyl)(2,7-di-tert-butylfluorenyl) hafnium dichloride, and their zirconium analogues.

Cocatalyst

To form an active catalytic species it is normally necessary to employ a cocatalyst as is well known in the art. It has now found that by using a specific aluminium containing cocatalyst in a catalyst system based on metallocenes provides advantageous performance in the high temperature solution process for producing ethylene copolymers.

The aluminium containing cocatalyst used according to the present invention is a solid alkyl alumoxane (AlkAO), also called alkyl aluminium oxide, wherein the alkyl group is a C₁ to C₆ alkyl, preferably a C₁ to C₃ alkyl. Most preferably the cocatalyst is a solid methylalumoxane (solid MAO). Essential is that the AlkAO is a solid compound.

The solid AlkAO used in the present invention as a cocatalyst is a solid, aliphatic hydrocarbon insoluble C₁ to C₆ alkyl alumoxane, more preferably is solid MAO.

Said solid AlkAO is preferably provided as a suspension in aliphatic hydrocarbon solvent or mixture of said aliphatic hydrocarbon solvents. Preferably, the solvent comprises one or more C₅ to C₂₄ aliphatic hydrocarbons, more preferably one or more C₆ to C₁₂ aliphatic hydrocarbons.

According to the more preferred embodiment the cocatalyst is solid MAO provided as a suspension in one or more C₅ to C₂₄ aliphatic hydrocarbons, more preferably in one or more C₆ to C₁₂ aliphatic hydrocarbons, especially as a slurry in decane or a mixture of decane and hexane.

In one preferred embodiment decane and hexane are used as a mixture of 50 to 70 wt-% decane and 50 to 30 wt-% hexane.

The average particle size (APS) of the solid MAO in the C₅ to C₂₄ aliphatic hydrocarbon, or mixtures thereof, may vary, but is preferably in the range of 2 to 20 μm, more preferably in the range of 4 to 12 μm, especially 4 to 10 μm.

The solid AlkAO suspension, preferably solid MAO suspension, used in the present invention in the preparation of the catalyst system has preferably content of solid MAO in the range of 3 to 30 wt-%, preferably in the range of 6 to 20 wt-%, more preferably 8 to 15 wt-%.

The Al content in the solid MAO is preferably in the range of 25 to 60 wt-%, preferably in the range of 30 to 50 wt-%. Especially in the range of 35 to 45 wt-%.

An example of such solid MAO is commercially available from Tosoh Finechem Corporation, and its production is described for example in EP2360191.

It is still further possible to add, into the polymerisation process or into the catalyst composition slurry, an additional aluminium alkyl compound as scavenger or additional alkylating agent. Suitable aluminium alkyl compounds are compounds of the formula AlR₃ with R being a linear or branched C₂-C₈-alkyl group.

Preferred aluminium alkyl compounds are triethylaluminium, tri-isobutylaluminium, tri-isohexylaluminium, tri-n-octylaluminium and tri-isooctylaluminium.

Thus, according to preferred embodiment the invention provides a catalyst system for producing ethylene copolymers in a high temperature solution process at a temperature greater than 100° C., the catalyst system comprising
(i) a metallocene complex of a group 4 transition metal comprising two ligands selected from optionally substituted cyclopentadienyl (Cp), Indenyl (Ind) and fluorenyl (Flu) ligands selected from metallocene complexes as defined in any of the formulas (I) to (V) and
(ii) a solid alkyl alumoxane cocatalyst (AlkAO), wherein the alkyl group (Alk) is a C₁ to C₆ alkyl, preferably a C₁ to C₃ alkyl.

Especially, the solid alkyl alumoxane cocatalyst (AlkAO) (ii) is provided as a suspension in an aliphatic C₅ to C₂₄ hydrocarbon solvent or mixture of said aliphatic hydrocarbon solvents.

Thus, according to preferred embodiment the invention provides a process for the preparation of an ethylene copolymer comprising polymerizing ethylene and a C₄₋₁₂ alpha-olefin comonomer in a high temperature solution process at a temperature greater than 100° C. in the presence of a catalyst system comprising:
(i) a metallocene complex of a group 4 transition metal comprising two ligands selected from optionally substituted cyclopentadienyl (Cp), Indenyl (Ind) and fluorenyl (Flu) ligands selected from metallocene complexes as defined in any of the formulas (I) to (V) and
(ii) a solid alkyl alumoxane cocatalyst, (AlkAO), wherein the alkyl group (Alk) is a C₁ to C₆ alkyl, preferably a C₁ to C₃ alkyl, and the solid alkyl alumoxane cocatalyst (AlkAO) is provided as a suspension in an aliphatic C₅ to C₂₄ hydrocarbon solvent or mixture of said aliphatic hydrocarbon solvents.

Viewed from another aspect the invention provides as a preferred embodiment use of a catalyst system comprising:
(i) a metallocene complex of a group 4 transition metal comprising two ligands selected from optionally substituted cyclopentadienyl (Cp), Indenyl (Ind) and fluorenyl (Flu) ligands selected from metallocene complexes as defined in any of the formulas (I) to (V) and
(ii) a solid alkyl alumoxane cocatalyst, wherein the alkyl group (Alk) is a C₁ to C₆ alkyl, preferably a C₁ to C₃ alkyl, provided as a suspension in an aliphatic C₅ to C₂₄ hydrocarbon solvent or mixture of said aliphatic hydrocarbon solvents,

in a high temperature solution process at a temperature greater than 100° C. for preparing ethylene C₄₋₁₂ alpha-olefin copolymers

Preferably the metallocene complexes used according to the present invention are of formulas (II) to (V), more preferably of formulas (III), (IV) and (V), still more preferably especially of formulas of formulas (IV) and (V), and especially of formula (V).

Manufacture of the Catalyst System

According to the present invention the metallocene complex is used in combination with the cocatalyst(s) as a catalyst system for the polymerization of ethylene and C₄₋₁₂ alpha-olefin comonomer in a high temperature solution polymerization process.

The catalyst system of the invention is prepared by
a) providing the solid AlkAO, preferably solid MAO as a suspension in a liquid aliphatic hydrocarbon,
b) contacting the suspension with the metallocene complex in solid form,
c) stirring the suspension for at least 2 h,
d) obtaining the product in a form of a slurry of alkylalumoxane-supported solid catalyst.

The product from step b) or c) can optionally be diluted with a light hydrocarbon solvent, like C₆ to C₁₂ alkanes or mixtures thereof, whereby the diluted suspension is obtained in step d).

The product obtained from step d) is dosed in a form of a slurry of alkylalumoxane-supported solid catalyst into the polymerisation reactor.

Thus, the catalyst system is prepared by first providing the solid AlkAO, preferably solid MAO as a suspension in an aliphatic hydrocarbon as defined above (step a)). This suspension is then contacted with the desired solid metallocene complex in an amount to reach the desired Al to Metal (Al/Mt) molar ratio (step b).

The suspension is then stirred, at a temperature between −20 to 100° C., preferably 0° C. to 50° C., most preferably between 20 and 40° C., for at least 2 h (aging time) to allow the metallocene complex to migrate from the solution to the solid alkylalumoxane (step c).

The suspension can be optionally further diluted, before or after the aging time, with light hydrocarbon solvent, like C₆ to C₁₂ alkanes or mixtures thereof, to reach the desired solid concentration in the slurry.

The obtained product is then in a form of a slurry of alkylalumoxane-supported solid catalyst, preferably a slurry of MAO-supported solid catalyst (step d).

Suitable amounts of cocatalyst (defined by molar ration of Al/Mt, where Mt is the transition metal in the metallocene complex) are well known to the skilled man.

In the obtained catalyst system the molar ratio of aluminium to the metal ion (Mt) of the metallocene (Al/Mt) may be in the range of 100 to 650 mol/mol, preferably in the range of 150 to 450 mol/mol, more preferably in the range of 200 to 400 mol/mol.

Polymer

The polymer to be produced using the catalyst system of the invention is a copolymer of ethylene and a C₄₋₁₂ alpha-olefin comonomer, preferably a C₄₋₁₀ alpha-olefin comonomer, like 1-butene, 1-hexene, 4-methyl-1-pentene, 1-octene etc. or mixtures thereof. Preferably, 1-butene, 1-hexene or 1-octene and most preferably 1-octene is used as comonomer. The comonomer content in such a polymer may be up to 45 mol %, preferably between 1 to 40 mol %, more preferably 1.5 to 35 mol % and even more preferably 2 to 25 mol %.

The density (measured according to ISO 1183-187) of the polymers is in the range of 0.850 g/cm³ to 0.930 g/cm³, preferably in the range of 0.850 g/cm³ to 0.920 g/cm³ and more preferably in the range of 0.850 g/cm³ to 0.910 g/cm³.

The melting points (measured with DSC according to ISO 11357-3:1999) of the polymers to be produced are below 130° C., preferably below 120° C., more preferably below 110° C. and most preferably below 100° C.

Polymerization

The catalyst system of the present invention is used to produce the above defined ethylene copolymers in a high temperature solution polymerization process at temperatures 100° C. or higher.

In view of this invention such process is essentially based on polymerizing the monomer and a suitable comonomer in a liquid hydrocarbon solvent in which the resulting polymer is soluble. The polymerization is carried out at a temperature above the melting point of the polymer, as a result of which a polymer solution is obtained. This solution is flashed in order to separate the polymer from the unreacted monomer and the solvent. The solvent is then recovered and recycled in the process.

A solution polymerization process is known for its short reactor residence times (compared to Gas-phase or slurry processes) allowing, thus, very fast grade transitions and significant flexibility in producing a wide product range in a short production cycle.

According to the present invention the used solution polymerization process is a high temperature solution polymerization process, using a polymerization temperature 100° C. or higher. Preferably the polymerization temperature is at least 110° C., more preferably at least 150° C. The polymerization temperature can be up to 250° C.

The pressure in the used solution polymerization process according to the invention is preferably in a range of 10 to 100 bar, preferably 15 to 100 bar and more preferably 20 to 100 bar.

The liquid hydrocarbon solvent used is preferably a linear, branched or cyclic aliphatic C₅₋₁₂-hydrocarbon such as pentane, hexane, heptane, octane, cyclohexane, methylcyclohexane and hydrogenated naphtha. More preferably C₆₋₁₀-hydrocarbon solvents are used.

Advantage

The new catalyst systems, comprising component (i) and (ii) can be advantageously used for ethylene copolymerization in a high temperature solution polymerization process.

The catalyst systems according to the present invention show improved balance of productivity, comonomer incorporation ability and molecular weight capability, if used for ethylene copolymerization in the high temperature solution polymerization process. The new catalyst system broadens the window of possible metallocene complexes, because the solubility of the metallocene complex is not anymore an issue, which allows selection of metallocenes within a broader window. Thus, the new catalyst system allows to select desired complexes based on desired properties and performance not to forget costs and availability of suitable complexes.

Additionally, by using the catalyst system of the invention, the use of borate based cocatalysts, like perfluorinated borates, is avoided. Further, aromatic solvents are not needed in preparing the catalyst system of the invention.

Applications

The polymers made by the catalyst system of the invention are useful in all kinds of end articles such as pipes, films (cast or blown films), fibers, moulded articles (e.g. injection moulded, blow moulded, rotomoulded articles), extrusion coatings and so on.

The invention will now be illustrated by reference to the following non-limiting examples.

### Examples

Methods

Quantification of Comonomer Content by NMR Spectroscopy

Quantitative nuclear-magnetic resonance (NMR) spectroscopy was used to quantify the comonomer content of the polymers.

Quantitative ¹³C{¹H} NMR spectra recorded in the molten-state using a Bruker Advance III 500 NMR spectrometer operating at 500.13 and 125.76 MHz for ¹H and ¹³C respectively. All spectra were recorded using a ¹³C optimised 7 mm magic-angle spinning (MAS) probe-head at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification. ^{[1],[2],[3],[4]} Standard single-pulse excitation was employed utilising the transient NOE at short recycle delays of 3s [5],[1] and the RS-HEPT decoupling scheme. ^{[6],[7]} A total of 1024 (1k) transients were acquired per spectrum. This setup was chosen due to its high sensitivity towards low comonomer contents.

Quantitative ¹³C{¹H} NMR spectra were processed, integrated and quantitative properties determined using custom spectral analysis automation programs. All chemical shifts are internally referenced to the bulk methylene signal (δ+) at 30.00 ppm. ^{[8]}

Characteristic signals corresponding to the incorporation of 1-octene were observed ^{[}8], [9], [10], [11], [12] and all comonomer contents calculated with respect to all other monomers present in the polymer.

Characteristic signals resulting from isolated 1-octene incorporation i.e. EEOEE comonomer sequences, were observed. Isolated 1-octene incorporation was quantified using the integral of the signal at 38.32 ppm. This integral is assigned to the unresolved signals corresponding to both _{*}B6 and _{*}βB6B6 sites of isolated (EEOEE) and isolated double non-consecutive

(EEOEOEE) 1-octene sequences respectively. To compensate for the influence of the two _{*}βB6B6 sites the integral of the ββB6B6 site at 24.7 ppm is used:

O=I_{*B6+*βB6B6}−2*I_{ββB6B6}

Characteristic signals resulting from consecutive 1-octene incorporation, i.e. EEOOEE comonomer sequences, were also observed. Such consecutive 1-octene incorporation was quantified using the integral of the signal at 40.48 ppm assigned to the ααB6B6 sites accounting for the number of reporting sites per comonomer:

OO=2*I_{ααB6B6}

Characteristic signals resulting from isolated non-consecutive 1-octene incorporation, i.e. EEOEOEE comonomer sequences, were also observed. Such isolated non-consecutive 1-octene incorporation was quantified using the integral of the signal at 24.7 ppm assigned to the ββB6B6 sites accounting for the number of reporting sites per comonomer:

OEO=2*I_{ββB6B6}

Characteristic signals resulting from isolated triple-consecutive 1-octene incorporation, i.e. EEOOOEE comonomer sequences, were also observed. Such isolated triple-consecutive 1-octene incorporation was quantified using the integral of the signal at 41.2 ppm assigned to the ααγB6B6B6 sites accounting for the number of reporting sites per comonomer:

OOO=3/2*I_{ααγB6B6B6}

With no other signals indicative of other comonomer sequences observed the total 1-octene comonomer content was calculated based solely on the amount of isolated (EEOEE), isolated double-consecutive (EEOOEE), isolated non-consecutive (EEOEOEE) and isolated triple-consecutive (EEOOOEE) 1-octene comonomer sequences:

Oₜₒₜₐₗ=O+OO+OEO+OOO

Characteristic signals resulting from saturated end-groups were observed. Such saturated end-groups were quantified using the average integral of the two resolved signals at 22.84 and 32.23 ppm. The 22.84 ppm integral is assigned to the unresolved signals corresponding to both 2B6 and 2S sites of 1-octene and the saturated chain end respectively. The 32.23 ppm integral is assigned to the unresolved signals corresponding to both 3B6 and 3S sites of 1-octene and the saturated chain end respectively. To compensate for the influence of the 2B6 and 3B6 1-octene sites the total 1-octene content is used:

S=(1/2)*(I_{2S+2B6}+I_{3S+3B6}−2*Oₜₒₜₐₗ)

The ethylene comonomer content was quantified using the integral of the bulk methylene (bulk) signals at 30.00 ppm. This integral included the γ and 4B6 sites from 1-octene as well as the δ+ sites. The total ethylene comonomer content was calculated based on the bulk integral and compensating for the observed 1-octene sequences and end-groups:

Eₜₒₜₐₗ=(1/2)*[I_{bulk}+2*O+1*OO+3*OEO+0*OOO+3*S]

It should be noted that compensation of the bulk integral for the presence of isolated triple-incorporation (EEOOOEE) 1-octene sequences is not required as the number of under and over accounted ethylene units is equal.

The total mole fraction of 1-octene in the polymer was then calculated as:

fO=(Oₜₒₜₐₗ/(Eₜₒₜₐₗ+Oₜₒₜₐₗ)

The total comonomer incorporation of 1-octene in weight percent was calculated from the mole fraction in the standard manner:

O[wt %]=100*(fO*112.21)/((fO*112.21)+((1−fO)*28.05))
[1] Klimke, K., Parkinson, M., Piel, C., Kaminsky, W., Spiess, H. W., Wilhelm, M., Macromol. Chem. Phys. 2006; 207:382.
[2] Parkinson, M., Klimke, K., Spiess, H. W., Wilhelm, M., Macromol. Chem. Phys. 2007; 208:2128.
[3] Castignolles, P., Graf, R., Parkinson, M., Wilhelm, M., Gaborieau, M., Polymer 50 (2009) 2373
[4] NMR Spectroscopy of Polymers: Innovative Strategies for Complex Macromolecules, Chapter 24, 401 (2011)
[5] Pollard, M., Klimke, K., Graf, R., Spiess, H. W., Wilhelm, M., Sperber, O., Piel, C., Kaminsky, W., Macromolecules 2004; 37:813.
[6] Filip, X., Tripon, C., Filip, C., J. Mag. Resn. 2005, 176, 239
[7] Griffin, J. M., Tripon, C., Samoson, A., Filip, C., and Brown, S.P., Mag. Res. in Chem. 2007 45, S1, S198
[8] J. Randall, Macromol. Sci., Rev. Macromol. Chem. Phys. 1989, C29, 201.
[9] Liu, W., Rinaldi, P., McIntosh, L., Quirk, P., Macromolecules 2001, 34, 4757
[10] Qiu, X., Redwine, D., Gobbi, G., Nuamthanom, A., Rinaldi, P., Macromolecules 2007, 40, 6879
[11] Busico, V., Carbonniere, P., Cipullo, R., Pellecchia, R., Severn, J., Talarico, G., Macromol. Rapid Commun. 2007, 28, 1128
[12] Zhou, Z., Kuemmerle, R., Qiu, X., Redwine, D., Cong, R., Taha, A., Baugh, D. Winniford, B., J. Mag. Reson. 187 (2007) 225

Gel Permeation Chromatography (GPC)

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-1:2003, ISO 16014-2:2003, ISO 16014-4:2003 and ASTM D 6474-12.

A high temperature GPC instrument, equipped with either infrared (IR) detector (IR4 or IR5 from PolymerChar (Valencia, Spain) or differential refractometer (RI) from Agilent Technologies, equipped with 3×Agilent-PLgel Olexis and 1×Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using universal calibration (according to ISO 16014-2:2003) with 19 narrow MWD polystyrene (PS) standards in the range of 0,5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

K_{PS}=19×10⁻³ mL/g, α_{PS}=0.655; K_{PE}=39×10⁻³ mL/g, α_{PE}=0.725

A third order polynomial fit was used to fit the calibration data.

All samples were prepared in the concentration range of 0,5-1 mg/ml and dissolved at 160° C. for 3 hours under continuous gentle shaking.

Determination of the Relative Comonomer Reactivity Ratio R

Ethylene concentration in liquid phase can be considered constant since total pressure is kept constant by feeding ethylene during polymerization. The C₈/C₂ ratio in solution at the end of the polymerization is calculated by subtracting the amount of octene incorporated in the polymer from the measured composition of the latter (% wt 1-octene)

The reactivity ratio, R, for each catalyst is then calculated as:

R=[(C₈/C₂)ₚₒₗ]/[(C₈/C₂)_{average in liquid phase}]

where (C₈/C₂) average in liquid phase is calculated as ((C₈/C₂)_{final}+(C₈/C₂)_{feed})/2

Average Particle Size (APS):

Malvern Method

The sample consisting of dry catalyst powder is mixed so that a representative test portion can be taken. Approximately 50 mg of sample is sampled in inert atmosphere into a 20 ml volume crimp cap vial and exact weight of powder recorded. A test solution is prepared by adding white mineral oil to the powder so that the mixture holds a concentration of approximately 0.5-0.7 wt-%. The test solution is carefully mixed before taking a portion that is placed in a measuring cell suitable for the instrument. The measuring cell should be such that the distance of between two optically clean glasses is at least 200 μm.

The image analysis is run at room temperature on a Malvern Morphologi 3G system. The measuring cell is placed on a microscopy stage with high precision movement in all directions. The physical size measurement in the system is standardised against an internal grating or by using an external calibration plate. An area of the measuring cell is selected so that the distribution of the particles is representative for the test solution. This area is recorded in partially overlapping images by a CCD camera and images stored on a system specific software via a microscope that has an objective sufficient working distance and a magnification of five times. Diascopic light source is used and the illumination intensity is adjusted before each run. All images are recorded by using a set of 4 focal planes over the selected area. The collected images are analysed by the software where the particles are individually identified by comparison to the background using a material predefined greyscale setting. A classification scheme is applied to the individually identified particles, such that the collected population of particles can be identified to belong to the physical sample. Based on the selection through the classification scheme further parameters can be attributed to the sample. The particle diameter is calculated as the circular equivalent (CE) diameter. The size range for particles included in the distribution is 6.8-200 μm. The distribution is calculated as a numerical moment-ratio density function distribution and statistical descriptors calculated based on the numerical distribution. The numerical distribution can for each bin size be recalculated for an estimate of the volume transformed distribution.

All graphical representations are based on a smothering function based on 11 points and the statistical descriptors of the population are based on the unsmothered curve. The mode is determined manually as the peak of the smothered frequency curve. Span is calculated as the (CE D[x,0.9]−CE D[x,0.1])/CE D[x,0.5].

Chemicals

Solid MAO (sMAO) was provided by Tosoh Finechem Corporation with the following information: Solid MAO (sMAO) was provided as a slurry with 13.7 wt % sMAO, 56 wt % decane and 30.3 wt % of C6-rich cut, and with an average particle size (APS) of sMAO of 5.6 micron, and with Al content in the sMAO of 42.1 wt %.

Modified MAO (MMAO-3A in heptane was provided by Akzo

As metallocene complexes were used:

MC1: Diphenylmethylene (cyclopentadienyl) (2,7-di-tert-butylfluorenyl) hafnium dimethyl

MC2: (phenyl)(5-n-butylthienyl) methylene(cyclopentadienyl)(2,7-di-tert-butylfluorenyl)hafnium dimethyl

1-octene as co-monomer (99%, Sigma Aldrich) was dried over molecular sieves and degassed with nitrogen before use.

Heptane and decane (99.9%, Sigma Aldrich) were dried under molecular sieves and degassed with nitrogen before use.

Isopar E was provided by ExxonMobil

Triethylaluminium (TEA) was provided by Sigma Aldrich

Cyclopentadienylmagnesium bromide was prepared according to the literature procedure [John R. Stille and Robert H. Grubbs, Intramolecular Diels-Alder Reaction of α,β-Unsaturated Ester Dienophiles with Cyclopentadiene and the Dependence on Tether Length, J. Org. Chem 1989, 54, 434-444].

Catalyst Preparation Examples

a) Complex Preparation:

Complex—MC1

### Diphenylmethylene (cyclopentadienyl) (2,7-di-tert-butylfluorenyl) hafnium dimethyl

Diphenylmethylene(cyclopentadienyl)(2,7-di-tert-butylfluoren-9-yl)hafnium dichloride was synthesized according to the literature Hopf, A, Kaminsky, W., Catalysis Communications 2002; 3:459.

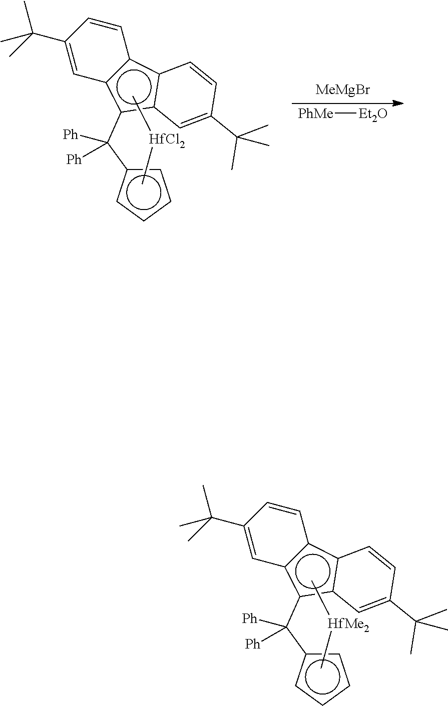

To a solution of 3.78 g (5.0 mmol) of [1-(η⁵-cyclopentadien-1-yl)-(η⁵-2,7-di-tert-butylfluorenyl)-1,1-diphenylmethane]hafnium dichloride in a mixture of 50 ml of toluene and 50 ml of ether 7.0 ml (14.77 mmol) of 2.11 M MeMgBr in ether was added. The resulting mixture was refluxed for 30 min and then evaporated to ca. 25 ml. The obtained mixture was heated to 80-90° C. and filtered while hot through glass frit (G4) to remove insoluble magnesium salts. The filter cake was additionally washed with 5×20 ml of warm hexane. The combined filtrate was evaporated to ca. 5 ml, and then 20 ml of hexane was added to the residue. Yellow powder precipitated from this solution was collected and dried in vacuum. This procedure gave 3.14 g (88%) of pure [1-η⁵-cyclopentadien-1-yl)-(η⁵-2,7-di-tert-butylfluorenyl)-1,1-diphenylmethane] hafnium dimethyl.

Anal. calc. for Ca₄₁H₄₄Hf: C, 68.85; H, 6.20. Found: C, 69.10; H, 6.37.

¹H NMR (CDCl₃): δ8.07 (d, J=8.9 Hz, 2H), 7.95 (br.d, J=7.9 Hz, 2H), 7.85 (br.d, J=7.9 Hz, 2H), 7.44 (dd, J=8.9 Hz, J=1.5 Hz, 2H), 7.37 (td, J=7.6 Hz, J=1.2 Hz, 2H), 7.28 (td, J=7.6 Hz, J=1.2 Hz, 2H), 7.24-7.17 (m, 2H), 6.26 (s, 2H), 6.20 (t, J=2.7 Hz, 2H), 5.45 (t, J=2.7 Hz, 2H), 1.03 (s, 18H), -1.90 (s, 6H). ¹³C{¹H} NMR (CDCl₃,): δ148.46, 145.75, 129.69, 128.63, 128.46, 126.73, 126.54, 123.29, 122.62, 120.97, 118.79, 116.09, 111.68, 107.76, 101.56, 76.47, 57.91, 37.61, 34.88, 30.84.

Complex—Mc2

### (5-n-butyl-2-thienyl)(phenyl)methylene(cyclopentadienyl)(2,7-di-tert-butylfluorenyl)hafnium dichloride

### Step 1: Synthesis of 2-butylthiophene

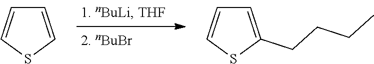

ⁿBuLi in hexanes (2.43 M, 176 ml, 427.7 mmol) was added dropwise over 40 min to a solution of thiophene (35.2 g, 418.3 mmol) in 200 ml of THF cooled to −78° C. This mixture was stirred for 1 h at 0° C., cooled to −40° C., and 60.2 g (439.4 mmol) of 1-bromobutane was added over a period of 5 min. The reaction mixture was allowed to reach room temperature and stirred overnight at this temperature. Then, it was quenched with 500 ml of water, and the resulting mixture was extracted with 3×250 ml of ether. The combined extract was dried over Na₂SO₄, concentrated under reduced pressure, and the residue was distilled in vacuum to give 37.0 g (63%) of 2-butylthiophene as a slightly yellowish liquid, b.p. 49-50° C./5 mm Hg.

¹H NMR (600 MHz, CDCl₃): δ 7.08 (dd, J=5.1 Hz, J=1.2 Hz, 1H), 6.90 (dd, J=5.1 Hz, J=3.4 Hz, 1H), 6.77 (m, 1H), 2.82 (t, J=7.7 Hz, 2H), 1.70-1.62 (m, 2H), 1.43-1.35 (m, 2H), 0.93 (t, J=7.4 Hz, 3H).

### Step 2: Synthesis of (5-butyl-2-thienyl)(phenyl)methanone

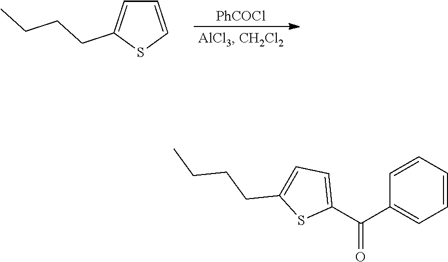

AlCl₃ (43.8 g, 328.5 mmol) was added in aliquots over 1 h to a solution of 2-butylthiophene (41.4 g, 295.2 mmol) and benzoyl chloride (45.6 g, 324.4 mmol) in 600 ml of dichloromethane cooled in an ice water bath. The reaction mixture was stirred additionally for 1 h at +5° C. (ice water bath) then it was poured into 500 g of crushed ice. The organic layer was separated, and the aqueous layer was extracted with 2×150 ml of dichloromethane. The combined organic extract was washed with 10% K₂CO₃ and dried over K₂CO₃. After removal of the solvents the residue was distilled in vacuum to give 54.8 g (76%) of (5-butyl-2-thienyl)(phenyl)methanone as a yellowish liquid, b.p. 165-175° C./5 mm Hg.

¹H NMR (600 MHz, CDCl₃): δ 7.85-7.79 (m, 2H), 7.58-7.52 (m, 1H), 7.50-7.43 (m, 3H), 6.85-6.83 (m, 1H), 2.87 (t, J=7.7 Hz, 2H), 1.74-1.66 (m, 2H), 1.45-1.37 (m, 2H), 0.94 (t, J=7.4 Hz, 3H). ¹³C{¹H} NMR (CDCl₃): δ 187.88, 156.44, 140.98, 138.27, 135.38, 131.85, 128.95, 128.24, 125.47, 33.36, 30.30, 22.06, 13.67.

### Step 3: Synthesis of 6-phenyl-6-(5-butyl-2-thienyl)fulvene

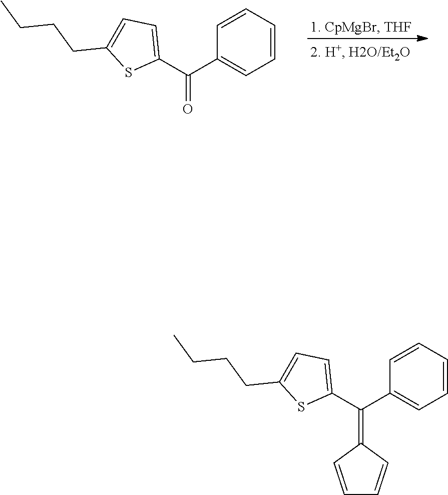

Cyclopentadienylmagnesium bromide (26.4 g, 154.75 mmol, 1.25 equiv.) in 200 ml THF was added in one portion to a solution of (5-butyl-2-thienyl)(phenyl)methanone (30.16 g, 123.43 mmol) in 50 ml of THF. The resulting red mixture was stirred overnight at room temperature to give deep-red solution which was poured into 1000 ml of water. Further on, 500 ml of ether was added followed by 10% HCl to a slightly acidic pH. The ethereal extract was separated and dried over Na₂SO₄. Removal of the solvent under vacuum gave dark-red oil. The product was isolated by flash-chromatography on silica gel 60 (40-63 μm; eluent: hexanes-ethyl acetate=200:1, vol.). This procedure gave 14.0 g (39%) of 6-phenyl-6-(5-butyl-2-thienyl)fulvene as red oil.

¹H NMR (600 MHz, CDCl₃): δ 7.43-7.33 (m, 5H), 6.90 (m, 1H), 6.85 (m, 1H), 6.75 (m, 1H), 6.61 (m, 1H), 6.47 (m, 1H), 6.01 (m, 1H), 2.82 (t, J=7.6 Hz, 2H), 1.67 (quintet, J=7.5 Hz, 2H), 1.40 (sextet, J=7.4 Hz, 2H), 0.93 (t, J=7.3 Hz, 3H). ¹³C{¹H} NMR (CDCl₃): δ 152.37, 144.49, 141.85, 141.28, 141.02, 133.47, 132.61, 131.55, 130.79, 128.65, 127.38, 125.13, 124.86, 122.76, 33.50, 30.11, 22.21, 13.76.

### Step 4: Synthesis of (phenyl)(5-n-butyl-2-thienyl)methylene(cyclopentadienyl)(2,7-di-tert-butylfluorenyl) hafnium dichloride (One-pot reaction form the fulvene)

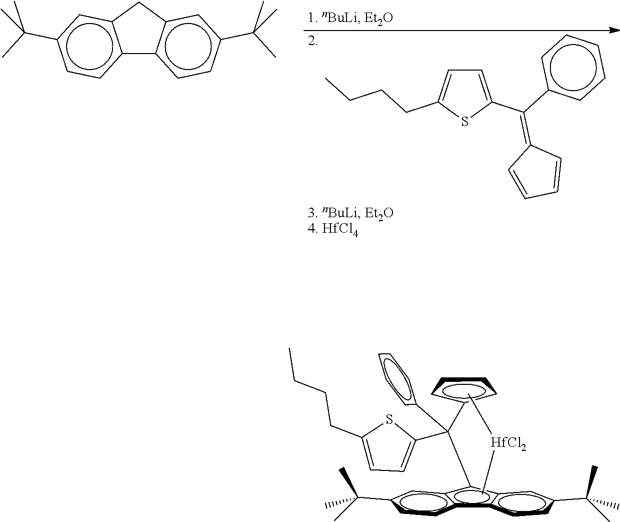

ⁿBuLi in hexanes (2.43 M, 19.7 ml, 47.87 mmol) was added in one portion to a solution of 2,7-di-tert-butylfluorene (13.33 g, 47.88 mmol) in 250 ml of ether cooled to −30° C. This mixture was stirred for 4 h at room temperature. The resulting orange solution was cooled to −30° C., and a solution of 14.0 g (47.87 mmol) of 6-phenyl-6-(5-butyl-2-thienyl)fulvene in 150 ml of ether was added in one portion. After stirring overnight at room temperature the red reaction mixture was cooled to −50° C., and 19.7 ml (47.87 mmol) of 2.43 M ⁿBuLi in hexanes was added in one portion. This mixture was stirred for 6 h at room temperature. The resulting dark-red solution was cooled to −60° C., and 15.34 g (47.89 mmol) of HfCl₄ was added. The mixture was stirred for 24 h at room temperature. The resulting dark-red mixture was evaporated almost to dryness, the residue was heated with 100 ml of n-hexane, and the obtained suspension filtered (G3) while hot. The obtained filtrate was evaporated to dryness, and the residue was triturated with 60 ml of n-pentane. The formed precipitate was filtered off (G3) and recrystallized from a toluene/n-hexane mixture. This procedure gave 5.8 g (15%) of (5-n-butyl-2-thienyl)(phenyl)methylene(cyclopentadienyl)(2,7-di-tert-butylfluorenyl)hafnium dichloride.

Anal. calc. for C₄₁H₄₄Cl₂HfS: C, 60.18; H, 5.42. Found: C, 60.33; H, 5.64.

¹H NMR (CDCl₃): δ 8.03 (d, J=8.8 Hz, 2H), 7.98-7.90 (m, 2H), 7.62 (dd, J=8.8 Hz, J=1.4 Hz, 1H), 7.58 (dd, J=8.8 Hz, J=1.4 Hz, 1H), 7.49 (td, J=7.7 Hz, J=1.2 Hz, 1H), 7.44 (br.s, 1H), 7.36 (br.d, J=6.3 Hz, 2H), 6.88-6.58 (m, 2H), 6.37-6.28 (m, 3H), 6.04-5.91 (m, 1H), 5.60 (dd, J=5.3 Hz, J=2.7 Hz, 1H), 2.88-2.67 (br.s, 2H), 1.78-1.58 (br.s, 2H), 1.50-1.35 (br.s, 2H), 1.19 (s, 9H), 1.06 (s, 9H), 1.01-0.87 (br.m, 3H).

### Step 5: Synthesis of (phenyl)(5-n-butyl-2-thienyl)methylene(cyclopentadienyl)(2,7-di-tert-butylfluorenyl) hafnium dimethyl

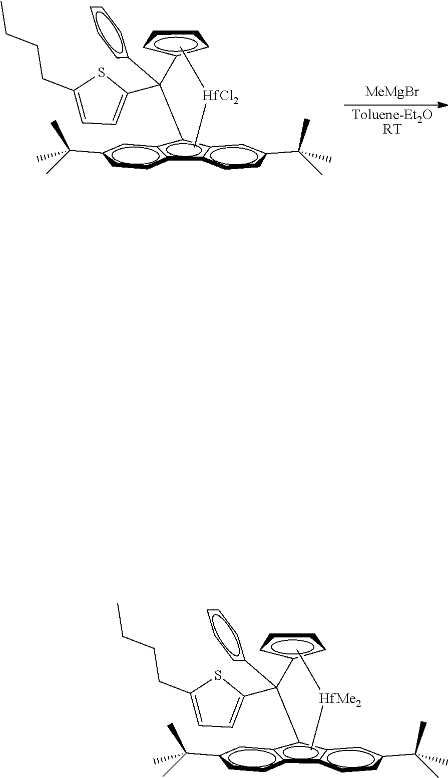

MeMgBr (3.0 M in ether, 5.7 ml, 17.1 mmol) was added to a solution of (5-n-butyl-2-thienyl)(phenyl)methylene(cyclopentadienyl)(2,7-di-tert-butylfluorenyl)hafnium dichloride (3.5 g, 4.28 mmol) in a mixture of 25 ml of toluene and 25 ml of ether. The resulting mixture was stirred at room temperature for 3 h and then evaporated to ca. 25 ml. The obtained suspension was filtered through glass frit (G3) to remove insoluble magnesium salts. The filter cake was additionally washed with 2×10 ml of toluene. The combined filtrate was evaporated almost to dryness, and 20 ml of n-hexane was added to the residue. The resulting mixture was filtered once again through a glass frit (G4). The mother liquor was evaporated to dryness, and the residue was dissolved in 10 ml of n-pentane. Yellow powder precipitated from this solution overnight at −25° C. was collected and dried in vacuum. This procedure gave 2.4 g (72%) of pure (5-n-butyl-2-thienyl)(phenyl)methylene(cyclopentadienyl)(2,7-di-tert-butylfluorenyl)hafnium dimethyl as a solvate with 0.5 molecule of n-hexane.

Anal. calc. for C₄₃H₅₀HfS×0.5 n-C₆H₁₄: C, 67.34; H, 7.00. Found: C, 67.68; H, 7.19.

¹H NMR (CDCl₃): δ 8.06 (d, J=8.8 Hz, 2H), 7.97-7.82 (m, 2H), 7.47 (dd, J=8.8 Hz, J=1.5 Hz, 1H), 7.45-7.36 (m, 2H), 7.36-7.20 (m, 3H), 6.76-6.42 (m, 2H), 6.26-6.13 (m, 3H), 5.75 (br.s, 1H), 5.39 (dd, J=5.2 Hz, J=2.7 Hz, 1H), 2.83-2.60 (br.s, 2H), 1.71-1.51 (br.s, 2H), 1.47-1.29 (br.s, 2H), 1.15 (s, 9H), 1.02 (s, 9H), 0.97-0.15 (br.m, 3H), −1.85 (s, 3H), −1.91 (s, 3H).

MMAO 3A Activation Procedure (for Comparative Examples)

The catalyst solution is prepared by dissolving the desired amount of complex into the MMAO solution to reach an Al/Hf molar ratio of 300.

For the polymerisation test, the desired solution aliquot is further diluted to 4 mL with isopar E and then injected in the polymerisation reactor after different contact times.

Solid MAO Activation Procedure (for Inventive Examples)

The catalytic system is prepared by contacting the sMAO suspension with the solid complex to reach a sMAO/Hf ˜300 mol/mol and further diluting it with isopar-E. The suspension is then stirred for at least 18 h before use.

During the first preparation, it has been observed that just after addition of the complex to the sMAO suspension the liquid phase appears coloured. The colour disappear after a few hours and after 18 hours the liquid is completely colourless indicating that all complex has migrated from the solution to the solid MAO.

For the polymerisation test, the desired slurry volume is adjusted to 4 mL with isopar-E (glove box) prior to injecting into the reactor.

Polymerisation Procedure

Same polymerisation conditions have been used for all complexes tested with both activators. The polymerisations have been performed in a 125 mL reactor equipped with a bottom valve. Different catalyst loadings were evaluated to achieve good temperature and pressure control and sufficient polymer production.

The reactor is charged at room temperature with 71 mL of solvent (isopar E) containing the scavenger (TEA, 35 μmol) and 9 mL of 1-octene. The temperature is then raised up to 160° C. and the reactor is carefully pressurised with ethylene (25-28 bar-g). When conditions are stable, the ethylene pressure is adjusted to 30 bar-g and the mixture is allowed to stir at 750 rpm during 10 minutes while feeding ethylene to keep constant pressure in order to determine the residual ethylene uptake.

After this time the catalytic system is injected in the reactor by nitrogen overpressure. Pressure is then kept constant by feeding ethylene and after 10 minutes polymerization is quenched by adding 3-4 bar CO₂ as killing agent. The reactor is then vented, the temperature is decreased and the content discharged in an aluminium pan. The reactor is then washed twice with isopar E and also the washings are collected in the aluminium pan. A few milligrams of Irganox 1076 (˜500 ppm related to the copolymer produced) are added. The pan is placed under a well-ventilated fume hood until the volatiles are evaporated and then the residual material is dried overnight in a vacuum oven at 55° C. The product was analysed by HT-SEC, DSC and NMR according to the methods reported in the polymer analytics paragraph.

Polymerisation results are shown in Table 1 and polymer analytics are disclosed in Table 2.

TABLE 1
C₂/C₈ copolymerisation with MC/sMAO/TEA
systems and MC/MMAO/TEA systems

| | | | MAO/MC | | C8/C2 | | | |
|---|---|---|---|---|---|---|---|---|
| | MC | | contact | | avg wt | Uptake | m_{copol} | Product. |
| Exp | mg/μmol | Activator | time | | ratio⁽¹⁾ | g C₂⁼ | g | kg/g_{MC} |
| IE1 | MC1 | sMAO | >18 | h | 1.5 | 0.97 | 1.27 | 4.4 |
| | 0.286/0.400 | | | | | | | |
| IE2 | MC2 | sMAO | >18 | h | 1.5 | 1.78 | 2.23 | 7.2 |
| | 0.310/0.400 | | | | | | | |
| CE1 | MC1 | MMAO 3A | 2 | d | 1.6 | 0.42 | 0.49 | 0.8 |
| | 0.644/0.900 | | | | | | | |
| CE2 | MC2 | MMAO 3A | 2 | d | 1.6 | 0.68 | 0.78 | 1.1 |
| | 0.700/0.900 | | | | | | | |

⁽¹⁾(C8/C2) average in liquid phase is calculated as ((C8/C2)final + (C8/C2)feed)/2 using Aspen plus

TABLE 2
MC/sMAO/TEA and MC/MMAO/TEA
polymer samples analytics results

| | | | % wt C8 in | | | |
|---|---|---|---|---|---|---|
| | | | polymer | Mₙ | M_{w} | |
| Exp | MC | Activator | (NMR) | kDa | kDa | PDI |
| IE1 | MC1 | sMAO | 18.1 | 67 | 102 | 2.2 |
| IE2 | MC2 | sMAO | 12.6 | 42 | 150 | 2.7 |
| CE1 | MC1 | MMAO 3A | 12.8 | 38 | 109 | 2.9 |
| CE2 | MC2 | MMAO 3A | 11.9 | 40 | 102 | 2.5 |

As can be seen from the results, productivity is clearly higher with the inventive catalyst systems than with the comparative catalyst systems. Further, comonomer incorporation ability is higher than in comparative examples.

Typically, higher comonomers such as 1-hexene or 1-octene have lower reactivity than ethylene, which means that polymerisation catalysts produce copolymers having a comonomer content lower than that of the reactor liquid phase. This means that efficient polymerisation catalysts must have also a comonomer incorporation capability as high as possible.

In addition, the molecular weight of a copolymer tends to decrease by increasing the comonomer content, especially at the high polymerisation temperatures and high conversion typical of solution polymerisation. The consequence is that often the range of achievable melt index values (molecular weight) at the lowest densities (highest comonomer content) is limited to the upper (lower) range.

This means that, for a polymerisation catalyst to be efficient, the decrease of the copolymer molecular weight with increasing comonomer content must be as low as possible. For MC1 very similar Mw is achieved with both activators, but MC1/sMAO shows a higher C8 incorporation. For MC2 the test with MMAO as activator gave a lower Mw compared to sMAO, at the same C8 content.

1. A catalyst system for producing ethylene copolymers in a high temperature solution process at a temperature greater than 100° C., the catalyst system comprising
(i) a metallocene complex of a group 4 transition metal comprising at least one ligand selected from optionally substituted cyclopentadienyl (Cp), indenyl (Ind) and fluorenyl (Flu) ligands and
(ii) a solid alkyl alumoxane cocatalyst, provided as a suspension in an aliphatic C₅ to C₂₄ hydrocarbon solvent or mixture of said aliphatic hydrocarbon solvents

2. A Catalyst system according to claim 1, wherein the metallocene complex in i) is of formula (A) or (B) 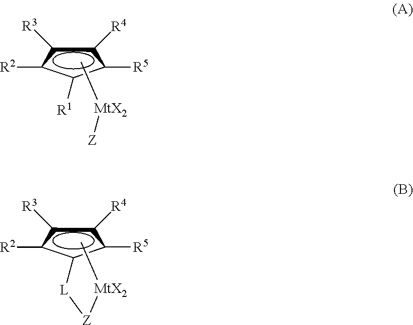
where
Z is a ligand coordinating to Mt,
Mt is Ti, Zr, Hf or a mixture of Zr and Hf, wherein the mixture of Zr and Hf is a mixture of complexes of formula (A) with Zr or Hf metal, or a mixture of complexes of formula (B) with Zr or Hf metal,
X is a sigma ligand,
L is a covalent bridge connecting the ligands,
R¹ to R⁵ are independently a hydrogen atom, a saturated or unsaturated, linear, branched or cyclic C₁-C₁₀ hydrocarbyl group, a C₆-C₁₀ aryl group, a C₆-C₂₀ alkylaryl group or a C₆-C₂₀ arylalkyl group, which optionally contains one or two heteroatoms or silicon atoms,
or two adjacent groups R¹ to R⁵ can form a ring comprising from 4 to 8 ring atoms, where the atoms being part of the formed ring can be substituted by one or more R¹² groups selected from saturated or unsaturated, linear or branched C₁-C₁₀ hydrocarbyl, a C₅-C₁₀aromatic group, C₆-C₂₀ alkylaryl or C₆-C₂₀ arylalkyl groups, which optionally contain one or two heteroatoms or silicon atoms.

3. A catalyst system of claim 1 wherein the metallocene complex in i) is of formula (A) or (B) 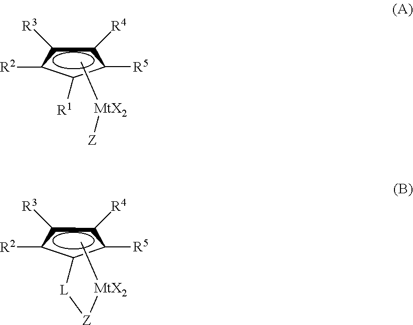
where
Z is a ligand coordinating to Mt,
Mt is Ti, Zr, Hf or mixture of Zr and Hf, wherein the mixture of Zr and Hf is a mixture of complexes of formula (A) with Zr or Hf metal, or a mixture of complexes of formula (B) with Zr or Hf metal,
X is a sigma ligand,
L is a covalent bridge connecting the ligands,
R¹ to R⁵ are independently a hydrogen atom, a saturated or unsaturated, linear, branched or cyclic C₁-C₁₀ hydrocarbyl group, a C₆-C₁₀ aryl group, a C₆-C₂₀ alkylaryl group or a C₆-C₂₀ arylalkyl group, in which up to two C atoms of the arylic ring(s) can be replaced by up to two heteroatoms, and which optionally carry substituents attached to their ring atoms, and such substituents optionally contain one or two heteroatoms or silicon atoms, or two adjacent groups of R¹ to R⁵ can form a ring comprising from 4 to 8 ring atoms, where the atoms being part of the formed ring can be substituted by one or more R¹² groups selected from saturated or unsaturated, linear or branched C₁-C₁₀ hydrocarbyl, a C₅-C₁₀ aromatic group, C₆-C₂₀ alkylaryl or C₆-C₂₀ arylalkyl groups, which optionally contain one or two heteroatoms or silicon atoms.

4. A Catalyst system according to claim 1, wherein the metallocene complex in i) is of formula (I) 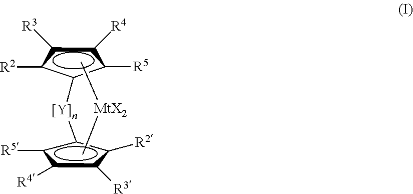
wherein
Mt is Zr, Hf or a mixture of Hf and Zr, wherein the mixture of Hf and Zr is a mixture of complexes of formula (I) with Zr or Hf metal,
X is a sigma ligand,
Y is a bridge of formula −(WR^{y})ₙ₋,
n is 1, 2 or 3, preferably 1 or 2, more preferably 1,
W is C or Si;
each R^{y} is independently a hydrogen atom, a saturated or unsaturated, linear, branched or cyclic C₁-C₁₀ hydrocarbyl group, a C₆-C₁₀ aryl, a C₆-C₂₀ alkylaryl group or a C₆-C₂₀ arylalkyl group, any of which optionally contains one or two heteroatoms or silicon atoms, or
a heteroatom-containing saturated or unsaturated ring of 3 to 7 ring-atoms optionally substituted with a linear, branched or cyclic saturated or unsaturated C₁ to C₂₀ hydrocarbyl group,
R² to R⁵ and R^{2′} to R^{5′} are independently hydrogen or a saturated or unsaturated, linear, branched or cyclic C₁-C₁₀ hydrocarbyl group, a C₆-C₁₀ aryl, C₆-C₂₀ alkylaryl or C₆-C₂₀ arylalkyl group, which optionally contain one or two heteroatoms or silicon atoms, or any two adjacent groups of R¹ to R⁵ and/or of R^{1′} to R^{5′} can form a ring comprising from 4 to 8 ring atoms, and the atoms being part of the formed ring may be further substituted by one or more R¹² groups selected from a saturated or unsaturated, linear or branched C₁-C₁₀ hyrocarbyl, a C₅-C₁₀ aromatic group, C₆-C₂₀ alkylaryl or C₆-C₂₀ arylalkyl groups, which may contain one or two heteroatoms or silicon atoms, or
R¹ to R⁵ and R^{2′} to R^{5′} are independently a hydrogen atom, a saturated or unsaturated, linear, branched or cyclic C₁-C₁₀ hydrocarbyl group, a C₆-C₁₀ aryl group, a C₆-C₂₀ alkylaryl group or a C₆-C₂₀ arylalkyl group, in which up to two C atoms of the arylic ring(s) can be replaced by up to two heteroatoms, and which optionally carry substituents attached to their ring atoms, and such substituents optionally contain one or two heteroatoms or silicon atoms, or two adjacent groups of R¹ to R⁵ and/or R^{2′} to R^{5′} can form a ring comprising from 4 to 8 ring atoms, where the atoms being part of the formed ring can be substituted by one or more R¹² groups selected from saturated or unsaturated, linear or branched C₁-C₁₀ hydrocarbyl, a C₅-C₁₀ aromatic group, C₆-C₂₀ alkylaryl or C₆-C₂₀ arylalkyl groups, which optionally contain one or two heteroatoms or silicon atoms, each X may be the same or different and is a sigma ligand, preferably a hydrogen atom, a halogen atom, a R¹⁴, OR¹⁴, OSO₂CF₃, OCOR¹⁴, SR¹⁴, NR¹⁴₂ or PR¹⁴₂ group, where R¹⁴ is a linear or branched, cyclic or acyclic, C₁-C₂₀-alkyl, C₂-C₂₀-alkenyl, C₂-C₂₀-alkynyl, C₆-C₂₀-aryl, C₇-C₂₀-alkylaryl or C₇-C₂₀-arylalkyl group optionally containing one or more heteroatoms belonging to groups 15 or 16, or is SiR¹⁴₃, SiHR¹⁴₂ or SiH₂R¹⁴, where R¹⁴ is preferably C₁₋₆-alkyl, phenyl or benzyl group,
preferably each X is independently a halogen atom or a R¹⁴ or OR¹⁴ group, whereby R¹⁴ is a C₁₋₆-alkyl, phenyl or benzyl group, most preferably X is methyl, chloro or benzyl group.

5. A Catalyst system according to claim 1, wherein the metallocene complex in i) is of formula (II) 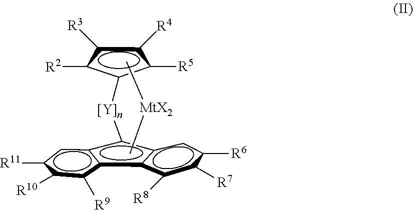
wherein
Mt is Zr, Hf or a mixture of Hf and Zr, wherein the mixture of Hf and Zr is a mixture of complexes of formula (II) with Zr or Hf metal,
Y is a bridge of formula −(WR^{y})ₙ₋,
n is 1, 2 or 3, preferably 1 or 2, more preferably 1
W is C or Si;
each R^{y} is as defined in formula (I),
each X is as defined in formula (I),
R² to R¹¹ are independently hydrogen or a saturated or unsaturated, linear, branched or cyclic C₁-C₁₀ hydrocarbyl group, a C₆-C₁₀ aryl, C₆-C₂₀ alkylaryl group or C₆-C₂₀ arylalkyl group, which optionally contain up to 2 heteroatoms or silicon atoms, or
any two adjacent groups of R² to R¹¹ can form a ring, comprising from 4 to 8 atoms. The atoms being part of the formed ring may be further substituted by one or more R¹² groups selected from or a saturated or unsaturated, linear or branched C₁-C₁₀ hydrocarbyl, a C₅—C₁₀ aromatic group, C₆-C₂₀ alkylaryl or C₆-C₂₀ arylalkyl groups, which may contain up to 2 heteroatoms or silicon atoms, or
R¹ to R¹¹ are independently a hydrogen atom, a saturated or unsaturated, linear, branched or cyclic C₁-C₁₀ hydrocarbyl group, a C₆-C₁₀ aryl group, a C₆-C₂₀ alkylaryl group or a C₆-C₂₀ arylalkyl group, in which up to two C atoms of the arylic ring(s) can be replaced by up to two heteroatoms, and which optionally carry substituents attached to their ring atoms, and such substituents optionally contain one or two heteroatoms or silicon atoms, or two adjacent groups of R¹ to R¹¹ can form a ring comprising from 4 to 8 ring atoms, where the atoms being part of the formed ring can be substituted by one or more R¹² groups selected from saturated or unsaturated, linear or branched C₁-C₁₀ hydrocarbyl, a C₅-C₁₀ aromatic group, C₆-C₂₀ alkylaryl or C₆-C₂₀ arylalkyl groups, which optionally contain one or two heteroatoms or silicon atoms.

6. A Catalyst system according to claim 1, wherein the metallocene complex in i) is of formula (V) 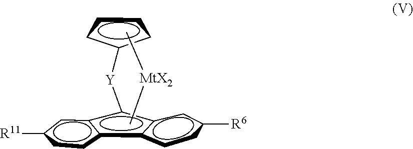
wherein Mt, X, Y and R⁶ and R¹¹ are as defined in claim 5, most preferably, R⁶ and R¹¹ are tertiary alkyl groups, X is methyl or chlorine, and Mt is Hf.

7. A catalyst system according to any of claims 1 to 6, wherein the solid alkyl alumoxane cocatalyst ii) is a solid alkyl alumoxane (AlkAO), wherein the alkyl group is a C₁ to C₆ alkyl, preferably a C₁ to C₃ alkyl.

8. A catalyst system according to any of the preceding claims, wherein the cocatalyst is a solid methylalumoxane (MAO).

9. A catalyst system according to claim 7 wherein the Al content in the solid MAO is in the range of 25 to 60 wt-%, preferably in the range of 30 to 50 wt-%.

10. A catalyst system according to any of the preceding claims, wherein the solid alkyl alumoxane cocatalyst is provided as a suspension in one or more aliphatic C₆ to C₁₂ hydrocarbon solvent.

11. A catalyst system according to claim 1 or 10, wherein the average particle size of the solid alkyl alumoxane cocatalyst in the suspension is of 2 to 20 μm, preferably in the range of 4 to 12 μm.

12. A catalyst system according to claim 11, wherein the content of the solid AlkAO, preferably solid MAO, in the suspension, is in the range of 3 to 30 wt-%, preferably in the range of 6 to 20 wt-%, more preferably 8 to 15 wt-%.

13. A process for producing a catalyst system comprising the steps
a) providing the solid AlkAO, preferably solid MAO, as a suspension in one or more liquid C₅ to C₂₄ aliphatic hydrocarbon solvents as defined in any of claims 7 to 12
b) contacting the suspension of step a) with the metallocene complex as defined in any of claims 1 to 6 in solid form
c) stirring the suspension for at least 2 h
d) obtaining the product in a form of a slurry of alkyl alumoxane-supported, preferably of MAO-supported solid catalyst.

14. The process according to claim 13, wherein the product from step b) or c) is diluted with light hydrocarbon solvent, preferably a solvent of C₆ to C₁₂ alkanes or mixtures thereof.

15. Use of a catalyst system as defined in any of claims 1 to 12 or prepared by the process as defined in claim 13 or 14 in a high temperature solution process at a temperature greater than 100° C. for copolymerizing ethylene and a C4-12 alpha-olefin comonomer.

16. Process for the preparation of an ethylene—C₄-C₁₂ copolymer comprising polymerizing ethylene and a C₄₋₁₀ alpha-olefin comonomer in a high temperature solution process at a temperature greater than 100° C. in the presence of a catalyst system as defined in any of the claims 1 to 12 comprising:
(i) a metallocene complex of as defined in any of preceding claims 1 to 6 and
(ii) a solid alkyl alumoxane cocatalyst as defined in any of the claim 1 or 7 to 12, or in the presence of a catalyst system prepared by the process as defined in claim 13 or 14.

17. Process according to claim 16, wherein the polymerization is performed
a) at a polymerization temperature of at least 110° C.,
b) a pressure in the range of 10 to 100 bar and
c) in a liquid hydrocarbon solvent selected from the group of C₅₋₁₂-hydrocarbons, which may be unsubstituted or substituted by C₁₋₄ alkyl group.

18. Ethylene copolymer obtained by a polymerization process according to claim 16 or 17.
